(19) United States
(12) Patent Application Publication
(10) Pub. No.: US 2025/0307528 A1
(43) Pub. Date: Oct. 2, 2025

(54) WEB PAGE GENERATION METHOD AND DEVICE

(71) Applicant: Beijing Zitiao Network Technology Co., Ltd., Beijing (CN)

(72) Inventors: Zhijun FEI, Beijing (CN); Deqi SUN, Beijing (CN); Shuai ZHU, Beijing (CN); Lei TAN, Singapore (SG)

(21) Appl. No.: 19/094,598

(22) Filed: Mar. 28, 2025

(30) Foreign Application Priority Data
Mar. 28, 2024 (CN) 202410370959.8

(51) Int. Cl. G06F 40/14; G06F 40/137; G06F 40/186

(52) U.S. Cl. CPC G06F 40/14; G06F 40/137; G06F 40/186

(57) ABSTRACT

The present disclosure provides a web page generation method and a device, and relates to the field of front-end development technologies. The method includes: obtaining requirement description information of a web page; inputting the requirement description information into an outline generation model to obtain web page outline information for describing web page logic; rendering the web page based on the web page outline information and a preset web page template; and generating the web page based on the web page outline information and the preset web page template in response to the web page being successfully rendered.

### CROSS-REFERENCE TO RELATED APPLICATION

The present application claims priority to Chinese Patent Application No. 202410370959.8, filed on Mar. 28, 2024, which is incorporated herein by reference in its entirety as a part of the present application.

### TECHNICAL FIELD

Embodiments of the present disclosure relate to a web page generation method and a device.

### BACKGROUND

Web pages are basic elements of a website, and web page elements included in the web pages may include, but are not limited to: text, image, audio, video, control, and the like. Therefore, web page development is to design display logic and interaction logic of web pages.

In the prior art, a product requirement document (PRD) of a web page is first created by a designer based on requirements, and the product requirement document includes requirement description information of the web page. The web page may then be developed by a developer based on the requirement description information. Finally, the web page can be published for users to use after a test of the web page succeeds.

However, the above solution has problems of high development costs and low development efficiency.

### SUMMARY

Embodiments of the present disclosure provide a web page generation method and a device, which can reduce the development costs of web pages and improve the development efficiency.

According to a first aspect, an embodiment of the present disclosure provides a web page generation method. The method includes:
obtaining requirement description information of a web page;
inputting the requirement description information into an outline generation model to obtain web page outline information for describing web page logic;
rendering the web page based on the web page outline information and a preset web page template; and
generating the web page based on the web page outline information and the preset web page template in response to the web page being successfully rendered.

According to a second aspect, an embodiment of the present disclosure provides a web page generation apparatus. The apparatus includes:
a requirement description obtaining module, configured to obtain requirement description information of a web page;
an outline generation module, configured to input the requirement description information into an outline generation model to obtain web page outline information for describing web page logic;
a first rendering module, configured to render the web page based on the web page outline information and a preset web page template; and
a web page generation module, configured to generate the web page based on the web page outline information and the preset web page template in response to the web page being successfully rendered.

According to a third aspect, an embodiment of the present disclosure provides an electronic device. The electronic device includes: at least one processor and a memory, where
the memory stores computer-executable instructions; and
the at least one processor executes the computer-executable instructions stored in the memory, to cause the electronic device to implement the method according to the first aspect.

According to a fourth aspect, an embodiment of the present disclosure provides a computer-readable storage medium storing computer-executable instructions that, when executed by a processor, cause a computing device to implement the method according to the first aspect.

According to a fifth aspect, an embodiment of the present disclosure provides a computer program product including a computer program that, when executed by a processor, causes the method according to the first aspect to be implemented.

### BRIEF DESCRIPTION OF DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and persons of ordinary skill in the art may still derive other drawings from these drawings without creative efforts.

FIG. 1 is a schematic diagram of a web page development flow according to some solutions;

FIG. 2 is a flowchart of steps of a web page generation method according to an embodiment of the present disclosure;

FIG. 3 is a flowchart of steps of another web page generation method according to an embodiment of the present disclosure;

FIG. 4 is a block diagram of a structure of a web page generation apparatus according to an embodiment of the present disclosure; and

FIG. 5 is a block diagram of a structure of an electronic device according to an embodiment of the present disclosure.

### DETAILED DESCRIPTION

To make the objectives, technical solutions and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All the other embodiments obtained by those of ordinary skill in the art based on the embodiments of the present disclosure without any creative effort shall fall within the scope of protection of the present disclosure.

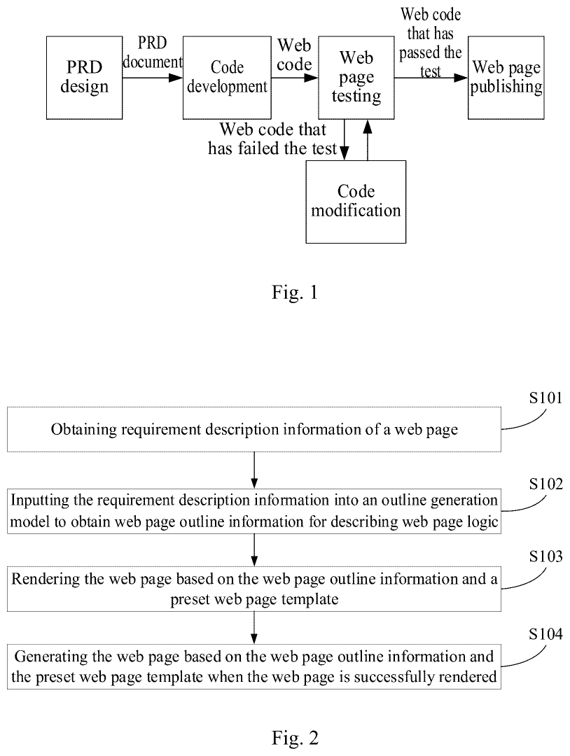

The embodiments of the present disclosure are applied in front-end development scenarios, specifically for developing web pages, which may also be referred to as world wide web (WEB) pages. In some solutions, web pages may be developed manually. FIG. 1 is a schematic diagram of a web page development flow according to some solutions. Referring to FIG. 1, the web page development flow involves four processes performed in sequence: a PRD design process, a code development process, a web page testing process, and a web page publishing process.

In the PRD design process described above, a PRD document that includes requirement description information of a web page for describing specific information of the web page can be written by a designer.

In the code development process, the requirement description information can be understood by a developer for writing web code.

In the web page testing process, the web code can be tested for each function by a tester so as to determine whether the functions of the web page are normal. If all the functions of the web page are normal, it indicates that the test has been passed, and the web code that has passed the test proceeds to the web page publishing process.

In the web page publishing process, the web page can be published to a system for use by users, which may also be referred to as a launch process.

In addition, as can be seen from FIG. 1, the web page development flow described above further includes a code modification process. When the functions of the web page are determined to be abnormal in the web page testing process, it can be determined that the web code has failed to pass the web code test, and the web code that has failed to pass the test proceeds to the code modification process. In the code modification process, the developer can modify the code involved with abnormal functions.

It can be understood that after the code modification process is completed, the web page testing process needs to be performed again to test whether the functions of the modified web code are normal. If the functions of the modified web code are normal, the web page publishing process is performed. If the functions of the modified web code are abnormal, the code modification process is performed again. In this way, the code modification process and the web page testing process can be performed repeatedly, until the web page testing process is passed.

However, the web page development flow described above requires the developer to write code, resulting in high development costs and low development efficiency of the web page.

In order to solve the above problems, the embodiments of the present disclosure contemplate low-code web page development, and represent web pages with web page outline information and preset web page templates. The web page outline information is used for describing web page logic, and the web page outline information varies from page to page. The preset web page templates are code templates for web pages, which are used for standardized style display. The preset web page templates have little change, so that they can be developed in advance, without a need to update or develop code templates frequently. Therefore, the web page development of the embodiments of the present disclosure mainly includes the generation of the web page outline information, which can avoid the development of code templates, so as to help to reduce development costs and improve development efficiency. In addition, the web page outline information may be text information to describe the web page logic in a text form, which may be obtained from requirement description information through an outline generation model, thereby reducing costs of generating the web page outline information, and further reducing the development costs of web pages and improving the development efficiency.

The technical solutions in the embodiments of the present disclosure and how the technical solutions of the present disclosure solve the above technical problems are described below in details with exemplary embodiments. The following several exemplary embodiments may be combined with each other, and details about same or similar concepts or processes may not be described in some embodiments again. The embodiments of the present disclosure are described below with reference to the accompanying drawings.

FIG. 2 is a flowchart of steps of a web page generation method according to an embodiment of the present disclosure. Referring to FIG. 2, the web page generation method includes the following steps.
S101: Obtaining requirement description information of a web page.

For example, the requirement description information can be extracted from a PRD document of the web page, and the requirement description information is used for describing requirements of the web page.
S102: Inputting the requirement description information into an outline generation model to obtain web page outline information for describing web page logic.

The web page outline information is a domain-specific language (DSL), and has text of a fixed format. For example, a commonly used DSL is JavaScript object notation (JSON), which represents web page logic in a form of key-value pairs.

The outline generation model in this embodiment of the present disclosure is used for generating the web page outline information, the input of the outline generation model may include at least the requirement description information, and the output of the outline generation model may include the web page outline information. The outline generation model may be a large language model (LLM), and a commonly used large language model may be the ChatGPT 4 model. For example, an input interface may be provided. A user may input the requirement description information in the input interface, or the user may upload the PRD document to the input interface, and the input interface extracts the requirement description information from the PRD document and inputs the requirement description information into the large language model.

The web page logic described by the web page outline information may be used for indicating display logic, input logic, interaction logic, etc., of the web page. Therefore, the web page outline information includes respective attribute information of at least one field in the web page. For example, if the web page is a form, when the user is required to input information such as a name, an account, and a password, the fields may be “name”, “account”, “password”, etc.

In this embodiment of the present disclosure, each field in the web page may be referred to as a first field, and the attribute information of each first field may be used for displaying the first field and controlling the interaction of a component of the first field. For example, the attribute information may include, but is not limited to: a type of the first field, a rendering strategy corresponding to the first field, a component identifier corresponding to the first field, linkage information corresponding to the first field, verification information of the first field, etc.

The type of the first field may include, but is not limited to: a character type, a value type, an enumeration type, a queue type, an object type, a range type, a text type, an arbitrary type, etc. For example, a type of the field “name” may be the text type, a type of the fields “account” and “password” may be the character type, and a type of a field “age” may be the value type. The type of the field may be set flexibly according to an actual application scenario.

The rendering strategy corresponding to the first field is used for describing whether the first field is readable or not. This embodiment of the present disclosure may use the same first field in a plurality of web pages and control, through the rendering strategy, whether the first field is read-only in different web pages. For example, the field “name” is editable in one web page A1, but read-only in another web page A2.

The rendering strategy described above may be widely used in details web pages and form web pages as the fields displayed in the details web pages and the form web pages are mostly the same, but the fields in the details web pages are read-only, while the fields in the form web pages are editable. Therefore, for example, a same field in the details web pages and the form web pages may share a set of components, but a rendering strategy of the field is set to be editable in the form web pages, while a rendering strategy of the field is set to be read-only in the details web pages.

The rendering strategy described above may also be widely used in list web pages and filter web pages as the fields displayed in the list web pages and the filter web pages are mostly the same, but the fields in the list web pages are read-only, while the fields in the filter web pages are editable. Therefore, for example, a same field in the list web pages and the filter web pages may share a set of components, but a rendering strategy of the field is set to be editable in the filter web pages, while a rendering strategy of the field is set to be read-only in the list web pages.

The component identifier of the first field is used for uniquely representing a component corresponding to the first field. The component corresponding to the first field may be any type of component, for example, a text region, a drop-down box, a select box, a display box, or a pop-up window, etc.

The linkage information corresponding to the first field may represent a dynamic relationship between the display of the first field and a second field. The second field may be any field that affects the display of the first field. That is, when the second field changes, the display of the first field changes. For example, the second field may be “region”, and the first field may be “device in the region”, such that when the first field “region” changes, options in the first field “device in the region” need to be updated.

The verification information of the first field is used for verifying the first field, and the verification information may specify a verification rule.

In addition, the attribute information of the first field may further include other information, for example, sub-fields, which may also be referred to as sub-options.

The above first field of the web page outline information may be a field for display or a field for control. This embodiment of the present disclosure expands the web page outline information by adding a scenario field and a group field to the web page outline information.

The scenario field is used for indicating a scenario to which the web page belongs, such that when a read-only scenario of the first field is indicated by another attribute information of the first field in the web page outline information, the first field is set to be read-only in the web page if the read-only scenario of the first field is consistent with the scenario field.

The group field is used for indicating a group in which the web page is located, and the group field can control web pages in the same group to use the same first field.
S103: Rendering the web page based on the web page outline information and a preset web page template.

The preset web page template may be a template that is common to all web pages, which is used for quick establishment of standardized web pages. It can be understood that the web page outline information is dynamic content that needs to be used to fill the template, and that the web page can be rendered by filling the preset web page template with the web page outline information. The preset web page template may be used for a type of web pages that may use different web page outline information.

The preset web page template may include one or more regions and basic attributes of the regions, such as shapes, sizes, margins, and fonts of the regions. For example, a preset web page template for a list web page may include: a web page title region, a filter region, and a list region.

The preset web page template may be a template for a web page, or may be determined from a plurality of candidate web page templates that have been developed in advance. For example, a template matching the requirement description information may be selected from the candidate web page templates based on the requirement description information, to serve as the preset web page template corresponding to the requirement description information. Alternatively, the corresponding preset web page template may be determined from the candidate web page templates that have been developed in advance, based on the scenario field and/or the group field in the web page outline information.

In addition, when the web page is rendered, a corresponding rendering interface for rendering may be further selected by a rendering SDK based on the scenario field and/or the group field described above.

In some implementations, each candidate web page template may have corresponding description information referred to as template description information, such that at least one of the requirement description information and the web page outline information can be text-matched with the template description information, and the candidate web page template corresponding to the successfully matched template description information can be used as the preset web page template for the web page outline information. In this way, the rendering can be performed with a selected template that is matched as much as possible on the basis of diversity of web page templates, which can improve the rendering effect.

It can be understood that the web page outline information is used for describing the web page logic, such that web page content can be displayed in the preset web page template based on the web page outline information, so as to render the web page.

In this embodiment of the present disclosure, the above web page rendering process may be implemented by a rendering software development kit (SDK). For example, the web page outline information and the preset web page template are input into the rendering SDK for rendering the web page.

It can be understood that the above web page of the embodiment of the present disclosure may be any type of web page, but rendering the web page based on the web page outline information and the preset web page template has a better advantage in management-related web pages. The management-related web pages can usually be used for adding functions, displaying query results, modifying functions, etc. The most complex logic in the management-related web pages is description of a form, and the form usually includes interaction logic, linkage logic, data processing logic, etc. Such complex logic may be implemented based on the attribute information of each first field in the web page described above in the embodiment of the present disclosure.
S104: Generating the web page based on the web page outline information and the preset web page template in response to the web page being successfully rendered.

It should be noted that when the web page fails to be rendered, the web page outline information can be modified, and then the web page can be re-rendered until the rendering succeeds, such that the web page can be generated based on the web page outline information and the preset web page template. Here, the process of generating the web page is a process of establishing a mapping relationship between the web page outline information, the preset web page template, and the web page, such that the web page can be rendered by retrieving the corresponding web page outline information and preset web page template when the web page needs to be rendered.

The generated web page can be stored in a web page library, such that the web page can be rendered repeatedly or modified later.

As can be seen from the description of S102, the web page outline information can be obtained by inputting the requirement description information into the outline generation model, and the outline generation model can select any existing component from a component library to render the web page. However, in some implementations, the outline generation model can be controlled to select a component from target existing components to render the web page. Therefore, the inputting the requirement description information into an outline generation model to obtain web page outline information may include the following steps.

First, a first vector of the requirement description information is generated. Then, the first vector is separately matched with a second vector of at least one existing component, to obtain at least one target existing component that matches the requirement description information, where the second vector is a vector of component description information of the existing component. Finally, the requirement description information and a component identifier of the at least one target existing component are input into the outline generation model to obtain the web page outline information for indicating that the web page uses the at least one target existing component.

The first vector is a vector of the requirement description information, which can be obtained by a text vector generation model. The text vector generation model is a machine model for generating a text vector. A commonly used text vector generation model is an embedding model, where the first vector of the requirement description information may be obtained by inputting the requirement description information into the embedding model.

After the first vector is obtained, the second vector needs to be further determined, and the second vector is a vector of the existing component. The second vector of the existing component may be generated in advance, and the second vector and a component identifier of the existing component are correspondingly stored in the component library. Such a method is referred to as a retrieval augmented generation (RAG) method. Therefore, compared to generating the second vector when generating the web page outline information, generating the second vector in advance can effectively improve the generation efficiency of the web page outline information, and thus improve the development efficiency of the web page.

The second vector of the existing component can be obtained from a component description text of the existing component. Similarly, the component description text can be input into the text vector generation model to obtain the second vector. The component description text may be stored in a component description file, and the component description text may be used for describing information such as the usage mode of the existing component. The existing component may be a built-in component provided by a platform or a custom component. The component description file of the built-in component may be provided by the platform or by a developer based on her/his understanding of the built-in component. The component description file of the custom component may be set after the custom component has been developed. The component identifier of the built-in component is provided by the platform, and the component identifier of the custom component may be set when the custom component is developed. The component identifier is used when the existing component is called, so as to specify, based on the component identifier, the existing component to be used.

After the second vector of each existing component is obtained, a similarity between the first vector and a second vector of each existing component may be calculated, and one or more existing components corresponding to one or more second vectors with the highest similarity relative to the first vector may be used as the target existing components.

After the target existing components are obtained, the component identifiers of the target existing components and the requirement description information can be input into the outline generation model, such that the web page outline information can be obtained. For example, the outline generation model can not only identify the fields included in the web page from the requirement description information, but also select the components used by the fields of the web page from the target existing components based on the requirement description information.

As can be seen, in this embodiment of the present disclosure, the web page outline information can be generated by using components selected from a plurality of existing components, which existing components may be all components in the component library, including built-in components provided by the platform, custom components, etc. Therefore, when the built-in components cannot meet business requirements, the custom components can be shared to meet the business requirements as much as possible. Moreover, the sharing of the custom components can improve the development efficiency of the web page based on the custom components.

After the web page is generated in step S104, the web page can be further displayed based on a web page outline identifier, where the web page can be previewed or modified when the web page is displayed. For example, the following steps are included. First, a first instruction is received, the first instruction carries a web page outline identifier of a target web page. Then, web page outline information of the target web page is obtained based on the web page outline identifier of the target web page. Finally, the target web page is rendered based on the web page outline information of the target web page and a preset web page template.

The first instruction is used for requesting to display the generated web page. The web page outline identifier of the target web page carried in the first instruction may be referred to as a target web page outline identifier, the target web page may be any web page generated by S101 to S104, and the target web page outline identifier may be any identifier.

For the process of rendering the target web page again, reference may be made to the process of S103 described above, and the principle is the same and will not be repeated herein. In this embodiment of the present disclosure, after the target web page is generated, the target web page may be displayed again based on the web page outline identifier, so as to detect whether the functions of the target web page are normal, which helps to ensure the normal operation of the target web page.

In some implementations, the displayed target web page may be further modified. For example, after the target web page is rendered based on the web page outline information of the target web page and the preset web page template, the target web page may be further modified through the following steps. First, a second instruction is received. Then, the web page outline information of the target web page and/or the preset web page template is modified based on the second instruction.

The second instruction is used for modifying the target web page and may carry the modified content for the target web page. The second instruction may be expressed in text, and is input by a user in a web page of a web page development tool. In this embodiment of the present disclosure, the web page outline information can be modified, and the preset web page template can be modified as well, thereby realizing secondary development of the web page, which can improve the personalization of the web page.

In some implementations, existing web page outline information may be further intelligently modified, which may include the following steps. First, a third instruction is received. Then, the third instruction and the existing web page outline information are input into the outline generation model to obtain the modified web page outline information.

The third instruction is used for indicating a strategy for modifying the existing web page outline information, and may be a text input by a user. Therefore, the outline generation model can generate, based on the third instruction, web page outline information different from the existing web page outline information as the modified web page outline information. Thus, compared to manually modifying the web page outline information, the web page outline information can be modified in conjunction with the outline generation model, which can reduce user modification costs and improve modification efficiency.

After the web page outline information is obtained through the aforementioned process, the web page can be rendered through step S103. In some implementations, step S103 may include the following steps. First, attribute information of each first field in the web page is extracted from the web page outline information, where the attribute information of the first field includes at least one of: a type of the first field, a rendering strategy corresponding to the first field, a component identifier corresponding to the first field, and linkage information corresponding to the first field. Rendering of the first field in the web page is controlled based on the attribute information of the first field.

It can be understood that in a conventional web page rendering scenario, the type of the first field is used for controlling the rendering of the first field, and different interfaces may be called when different types of fields are rendered, resulting in different rendering modes. In addition, in this embodiment of the present disclosure, the type of the first field is further used for determining a component of the first field, and a default first component may be determined based on the type of the first field when a component corresponding to the component identifier does not exist, so as to ensure that the first field is rendered successfully, thereby ensuring that the web page is rendered successfully.

The rendering strategy corresponding to the first field is used for describing whether the first field is readable or not, and it may be determined that the first field is readable in the web page based on the rendering strategy.

The component identifier of the first field is used for uniquely representing a component corresponding to the first field. The component identifier of the first field is used for determining the component of the first field, so that the first field is rendered through the component.

It can be understood that the attribute information of the first field may include attributes for controlling the rendering, and other attributes not used for rendering, for example, attributes used for interaction. In this embodiment of the present disclosure, the fields to be rendered and how to render the fields in rendering the web page may be determined based on the web page outline information, such that the web page can be rendered more flexibly and accurately.

In some implementations, when the attribute information of the first field includes the type of the first field and the component identifier corresponding to the first field, the controlling rendering of the first field in the web page based on the attribute information of the first field includes the following steps. First, it is determined whether a component of the component identifier corresponding to the first field exists or not, which respectively correspond to different determination processes of the first component. Then, the first field is rendered in a form of the first component based on the rendering strategy corresponding to the first component, where the rendering strategy is used for indicating whether the first field is read-only in the web page.

The determination processes of the first component described above may include the following steps. A component corresponding to the component identifier corresponding to the first field is determined as a first component if the component of the component identifier corresponding to the first field exists. A component corresponding to the type of the first field is obtained as the first component from the at least one existing component if the component identifier corresponding to the first field does not exist and/or the component corresponding to the component identifier corresponding to the first field does not exist. The first field is rendered in the web page in a form of the first component.

For example, the first field may be rendered in the form of the first component based on the rendering strategy corresponding to the first field, where the rendering strategy is used for indicating whether the first component is rendered in a read-only manner.

It can be understood that the process of determining whether the component corresponding to the component identifier exists may be: matching the component identifier of the first field with component identifiers of the existing components in the component library one by one. When the component identifier of the first field matches the component identifier of an existing component in the component library, it indicates that the component of the component identifier corresponding to the first field exists, i.e., the component is the existing component. When the component identifier of the first field does not match the component identifier of any one of existing components in the component library, it indicates that the component of the component identifier corresponding to the first field does not exist.

In this embodiment of the present disclosure, the component corresponding to the component identifier is preferentially used as the first component for rendering the first field, so as to meet the rendering requirements of the web page outline information as much as possible. When the component corresponding to the component identifier does not exist, the first component may be determined based on the type of the first field, so as to ensure the rendering to be successful as much as possible.

When the attribute information of the first field includes the rendering strategy of the first field, the controlling rendering of the first field in the web page based on the attribute information of the first field includes the following steps. First, scenario information of the web page is obtained from the web page outline information. Then, the scenario information is matched with the rendering strategy to determine whether the first field is rendered in the web page in a read-only manner.

The scenario information of the web page is used for indicating a business scenario to which the web page corresponds, which may also be understood as a type of the web page. For example, the web page is a details web page or a form web page. The rendering strategy may be used for indicating a business scenario where the first field is read-only, or a business scenario where the first field is editable.

When the rendering strategy is used for indicating a scenario where the first field is read-only, if the read-only scenario included in the rendering strategy of the first field is consistent with the business scenario of the web page, the first field in the web page is rendered in a read-only manner. When the rendering strategy is used for indicating a scenario where the first field is read-only, if the read-only scenario included in the rendering strategy of the first field is inconsistent with the business scenario of the web page, the first field in the web page is rendered in an editable manner.

Similarly, when the rendering strategy is used for indicating a scenario where the first field is editable, if the editable scenario included in the rendering strategy of the first field is consistent with the business scenario of the web page, the first field in the web page is rendered in an editable manner. When the rendering strategy is used for indicating a scenario where the first field is editable, if the editable scenario included in the rendering strategy of the first field is inconsistent with the business scenario of the web page, the first field in the web page is rendered in a read-only manner.

In this embodiment of the present disclosure, the scenario information of the web page may be combined with the rendering strategy to provide more flexibility in controlling the rendering of the fields in the web page and to improve the rendering flexibility.

In some implementations, when the attribute information of the first field includes the linkage information corresponding to the first field, where the linkage information is represented by a function expression, the controlling rendering of the first field in the web page based on the attribute information of the first field includes the following steps. First, a second field on which the first field depends is determined based on the linkage information. Then, when the second field is updated, the rendering of the first field is updated through the function expression.

The second field is a field on which the first field depends, and may be located on the same web page as the first field. The linkage information denotes a relationship between the display of the first field and the change of the second field by a function expression, where the function expression indicates a relationship between at least one attribute of the first field and at least one attribute of the second field. Therefore, when at least one attribute of the second field is updated, the related attribute of the updated first field may be determined based on the function expression, so as to achieve the purpose of updating the first field.

In practical application, the function expression may be indicated with specific identifiers. For example, the function expression starts with a start identifier and ends with an end identifier, such that the rendering SDK obtains the function expression accurately.

In some implementations, when the attribute information of the first field further includes verification information of the first field, which may be an array including one or more verification rules, in each of the verification rules, one type of verification may be performed, so as to verify the first field in a plurality of aspects. Therefore, the first field is verified based on the verification information upon receiving a fourth instruction on a form in the web page.

The fourth instruction may be a verification-only instruction, or a submit instruction on a form in the web page, for verifying each first field in the web page when the form is submitted. The verification process may be implemented by an asynchronous verifier. In this way, the data in the form is guaranteed to be accurate.

In some implementations, before S103, group information of the web page and/or scenario information of the web page may be further extracted from the web page outline information, and a preset web page template may be determined from at least one candidate web page template based on the group information and/or the scenario information.

The group information is used for indicating a group in which the web page is located and may be a group identifier. In this embodiment of the present disclosure, a plurality of web pages of software may be grouped, and a group identifier may be determined for each group, so as to manage the web pages based on groups.

In practical application, a plurality of candidate web page templates may be provided, and each candidate web page template corresponds to at least one piece of group information and/or at least one piece of scenario information to indicate that the candidate web page template can be used in a group corresponding to the group information, and/or the candidate web page template can be used in a scenario corresponding to the scenario information. Therefore, before a web page is rendered, a web page template matching the group information and/or the scenario information of the web page needs to be selected from one or more candidate web page templates as a preset web page template for the web page.

As can be seen, in this embodiment of the present disclosure, the rendering effect can be improved by providing different templates for rendering only for different scenarios or groups.

In summary, in this embodiment of the present disclosure, intelligent development of web pages can be achieved based on the web page outline information and the preset web page template. The web page outline information is in a form of text, and the preset web page template is front-end code. Therefore, in this embodiment of the present disclosure, web page development is converted from code development to generation of web page outline information, which can reduce a code amount, reduce development costs of web pages, and improve development efficiency of web pages.

In addition, in some conventional low-code development platforms, low-code development is achieved by dragging components and inputting additional information, that is, the code development costs are converted into configuration costs, which results in low development efficiency. However, in this embodiment of the present disclosure, the web page outline information is generated by a large model, which reduces the costs of generating the web page outline information and improves the generation efficiency of the web page outline information, thereby reducing the development costs of web pages, and improving the development efficiency of web pages.

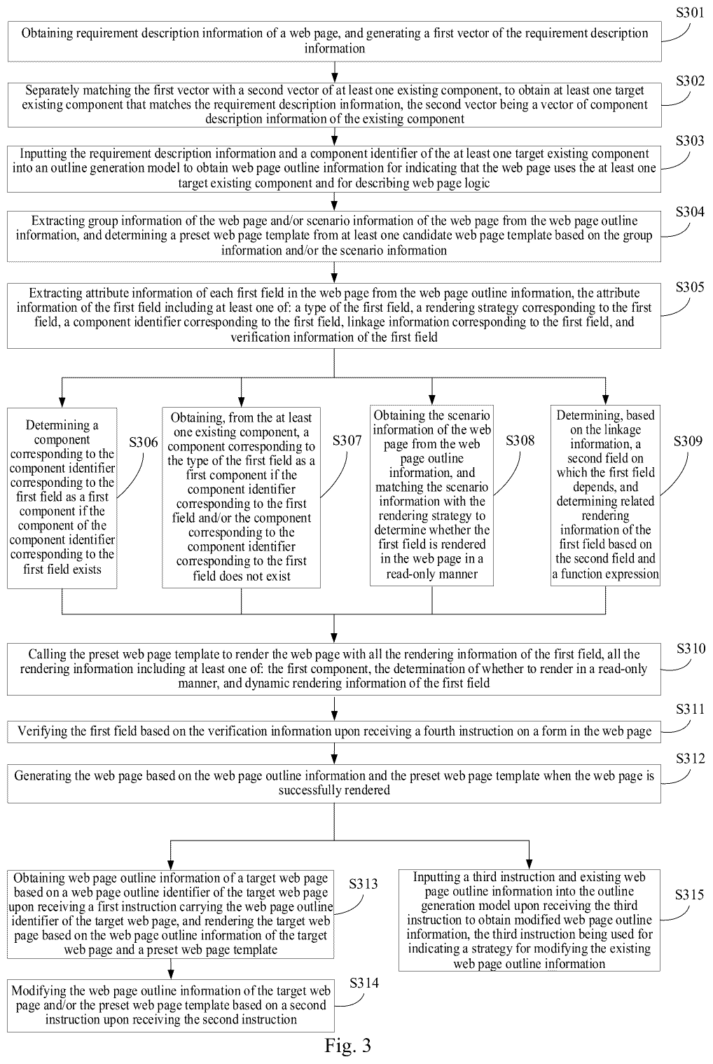

FIG. 3 is a flowchart of steps of another web page generation method according to an embodiment of the present disclosure. Referring to FIG. 3, the web page generation method may include the following steps.
S301: Obtaining requirement description information of a web page, and generating a first vector of the requirement description information.
S302: Separately matching the first vector with a second vector of at least one existing component, to obtain at least one target existing component that matches the requirement description information, the second vector being a vector of component description information of the existing component.
S303: Inputting the requirement description information and a component identifier of the at least one target existing component into an outline generation model to obtain web page outline information for indicating that the web page uses the at least one target existing component and for describing web page logic.
S304: Extracting group information of the web page and/or scenario information of the web page from the web page outline information, and determining a preset web page template from at least one candidate web page template based on the group information and/or the scenario information.
S305: Extracting attribute information of each first field in the web page from the web page outline information, the attribute information of the first field including at least one of: a type of the first field, a rendering strategy corresponding to the first field, a component identifier corresponding to the first field, linkage information corresponding to the first field, and verification information of the first field. S306 or S307 or S308 or S309 may be performed after S305.
S306: Determining a component corresponding to the component identifier corresponding to the first field as a first component if the component of the component identifier corresponding to the first field exists.
S307: Obtaining, from the at least one existing component, a component corresponding to the type of the first field as the first component if the component identifier corresponding to the first field and/or the component corresponding to the component identifier corresponding to the first field does not exist.
S308: Obtaining the scenario information of the web page from the web page outline information, and matching the scenario information with the rendering strategy to determine whether the first field is rendered in the web page in a read-only manner.
S309: Determining, based on the linkage information, a second field on which the first field depends, and determining dynamic rendering information of the first field based on the second field and a function expression.
S310 needs to be performed after each of S306, S307, S308 and S309.
S310: Calling the preset web page template to render the web page with all the rendering information of the first field, all the rendering information including at least one of: the first component, the determination of whether to render in a read-only manner, and the dynamic rendering information of the first field.
S311: Verifying the first field based on the verification information upon receiving a fourth instruction on a form in the web page.
S312: Generating the web page based on the web page outline information and the preset web page template in response to the web page being successfully rendered.
S313: Obtaining web page outline information of a target web page based on a web page outline identifier of the target web page upon receiving a first instruction carrying the web page outline identifier of the target web page, and rendering the target web page based on the web page outline information of the target web page and a preset web page template.
S314: Modifying the web page outline information of the target web page and/or the preset web page template based on a second instruction upon receiving the second instruction.
S315: Inputting a third instruction and existing web page outline information into the outline generation model upon receiving the third instruction to obtain modified web page outline information, the third instruction being used for indicating a strategy for modifying the existing web page outline information.

It should be noted that the steps shown in FIG. 3 may be flexibly adjusted in sequence on the basis of mutual independence. In addition, for the above web page generation method, reference may be made to the corresponding description of the web page generation method shown in FIG. 2, and details are not repeated herein.

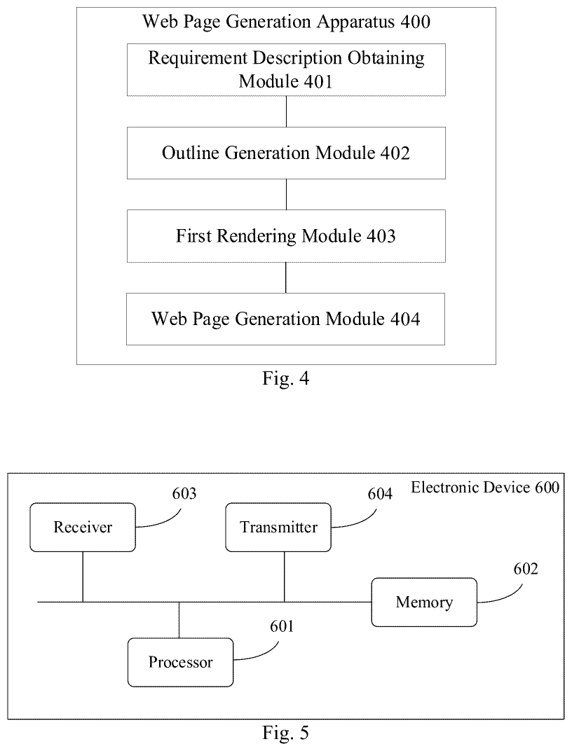

Corresponding to the web page generation method in the above embodiments, FIG. 4 is a block diagram of a structure of a web page generation apparatus according to an embodiment of the present disclosure. For ease of illustration, only parts related to this embodiment of the present disclosure are shown. Referring to FIG. 4, the web page generation apparatus 400 includes:
a requirement description obtaining module 401, configured to obtain requirement description information of a web page;
an outline generation module 402, configured to input the requirement description information into an outline generation model to obtain web page outline information for describing web page logic;
a first rendering module 403, configured to render the web page based on the web page outline information and a preset web page template; and
a web page generation module 404, configured to generate the web page based on the web page outline information and the preset web page template in response to the web page being successfully rendered.

Optionally, the outline generation module 402 is further configured to:
generate a first vector of the requirement description information; separately match the first vector with a second vector of at least one existing component, to obtain at least one target existing component that matches the requirement description information, the second vector being a vector of component description information of the existing component; and input the requirement description information and a component identifier of the at least one target existing component into the outline generation model to obtain the web page outline information for indicating that the web page uses the at least one target existing component.

Optionally, the apparatus further includes:
a first instruction receiving module, configured to receive a first instruction, the first instruction carrying a web page outline identifier of a target web page;
a web page outline obtaining module, configured to obtain web page outline information of the target web page based on the web page outline identifier of the target web page; and
a second rendering module, configured to render the target web page based on the web page outline information of the target web page and the preset web page template.

Optionally, the apparatus further includes:
a second instruction receiving module, configured to receive a second instruction after the target web page is rendered based on the web page outline information of the target web page and the preset web page template; and
a first web page modifying module, configured to modify the web page outline information of the target web page and/or the preset web page template based on the second instruction.

Optionally, the apparatus further includes:
a third instruction receiving module, configured to receive a third instruction; and
a second web page modifying module, configured to input the third instruction and existing web page outline information into the outline generation model to obtain modified web page outline information, the third instruction being used for indicating a strategy for modifying the existing web page outline information.

Optionally, the first rendering module 403 is further configured to:
extract attribute information of each first field in the web page from the web page outline information, the attribute information of the first field including at least one of: a type of the first field, a rendering strategy corresponding to the first field, a component identifier corresponding to the first field, and linkage information corresponding to the first field; and control rendering of the first field in the web page based on the attribute information of the first field.

Optionally, when the attribute information of the first field includes the type of the first field and the component identifier corresponding to the first field, the first rendering module 403 is further configured to:
determine a component corresponding to the component identifier corresponding to the first field as a first component if the component of the component identifier corresponding to the first field exists; or obtain, from the at least one existing component, a component corresponding to the type of the first field as a first component if the component identifier corresponding to the first field and/or the component corresponding to the component identifier corresponding to the first field does not exist; and render the first field in the web page in a form of the first component based on the rendering strategy corresponding to the first component, the rendering strategy being used for indicating whether the first field is read-only in the web page.

Optionally, when the attribute information of the first field includes the rendering strategy of the first field, the first rendering module 403 is further configured to:
obtain scenario information of the web page from the web page outline information; and match the scenario information with the rendering strategy to determine whether the first field is rendered in the web page in a read-only manner. Optionally, when the attribute information of the first field includes the linkage information corresponding to the first field, the linkage information being represented by a function expression, the first rendering module 403 is further configured to:
determine, based on the linkage information, a second field on which the first field depends; and render the first field based on the second field and the function expression.

Optionally, when the attribute information of the first field further includes verification information of the first field, the apparatus further includes:
a verifying module, configured to verify the first field based on the verification information upon receiving a fourth instruction on a form in the web page.

Optionally, the apparatus further includes:
a group and scenario obtaining module, configured to extract group information of the web page and/or scenario information of the web page from the web page outline information before the web page is rendered based on the web page outline information and the preset web page template; and
a template selecting module, configured to determine the preset web page template from at least one candidate web page template based on the group information and/or the scenario information.

The web page generation apparatus provided in this embodiment may be configured to perform the technical solution of the above embodiments of the web page generation method. The implementation principle and technical effects thereof are similar, and are not described herein again in this embodiment.

FIG. 5 is a block diagram of a structure of an electronic device according to an embodiment of the present disclosure. The electronic device 600 includes a memory 602 and at least one processor 601.

The memory 602 stores computer-executable instructions.

The at least one processor 601 executes the computer-executable instructions stored in the memory 602, to cause the electronic device 600 to implement the web page generation method as described above.

In addition, the electronic device may further include a receiver 603 and a transmitter 604. The receiver 603 is configured to receive information from other apparatuses or devices and forward the information to the processor 601. The transmitter 604 is configured to transmit information to other apparatuses or devices.

In a first example of a first aspect, an embodiment of the present disclosure provides a web page generation method. The method includes:
obtaining requirement description information of a web page; inputting the requirement description information into an outline generation model to obtain web page outline information for describing web page logic; rendering the web page based on the web page outline information and a preset web page template; and generating the web page based on the web page outline information and the preset web page template in response to the web page being successfully rendered.

Based on the first example of the first aspect, in a second example of the first aspect, the inputting the requirement description information into an outline generation model to obtain web page outline information includes:
generating a first vector of the requirement description information; separately matching the first vector with a second vector of at least one existing component, to obtain at least one target existing component that matches the requirement description information, the second vector being a vector of component description information of the existing component; and inputting the requirement description information and a component identifier of the at least one target existing component into the outline generation model to obtain the web page outline information for indicating that the web page uses the at least one target existing component.

Based on the second example of the first aspect, in a third example of the first aspect, the method further includes:
receiving a first instruction, the first instruction carrying a web page outline identifier of a target web page; obtaining web page outline information of the target web page based on the web page outline identifier of the target web page; and rendering the target web page based on the web page outline information of the target web page and the preset web page template.

Based on the third example of the first aspect, in a fourth example of the first aspect, after the rendering the target web page based on the web page outline information of the target web page and the preset web page template, the method further includes:
receiving a second instruction; and modifying the web page outline information of the target web page and/or the preset web page template based on the second instruction.

Based on the first to fourth examples of the first aspect, in a fifth example of the first aspect, the method further includes:
receiving a third instruction; and inputting the third instruction and existing web page outline information into the outline generation model to obtain modified web page outline information, the third instruction being used for indicating a strategy for modifying the existing web page outline information.

Based on the first to fourth examples of the first aspect, in a sixth example of the first aspect, the rendering the web page based on the web page outline information and a preset web page template includes:
extracting attribute information of each first field in the web page from the web page outline information, the attribute information of the first field including at least one of: a type of the first field, a rendering strategy corresponding to the first field, a component identifier corresponding to the first field, and linkage information corresponding to the first field; and controlling rendering of the first field in the web page based on the attribute information of the first field.

Based on the sixth example of the first aspect, in a seventh example of the first aspect, when the attribute information of the first field includes the type of the first field and the component identifier corresponding to the first field, the controlling rendering of the first field in the web page based on the attribute information of the first field includes:
determining a component corresponding to the component identifier corresponding to the first field as a first component if the component of the component identifier corresponding to the first field exists; or obtaining, from the at least one existing component, a component corresponding to the type of the first field as a first component if the component identifier corresponding to the first field and/or the component corresponding to the component identifier corresponding to the first field does not exist; and rendering the first field in the web page in a form of the first component based on the rendering strategy corresponding to the first component, the rendering strategy being used for indicating whether the first field is read-only in the web page.

Based on the sixth example of the first aspect, in an eighth example of the first aspect, the controlling rendering of the first field in the web page based on the attribute information of the first field includes:
obtaining scenario information of the web page from the web page outline information; and matching the scenario information with the rendering strategy to determine whether the first field is rendered in the web page in a read-only manner.

Based on the sixth example of the first aspect, in a ninth example of the first aspect, when the attribute information of the first field includes the linkage information corresponding to the first field, the linkage information being represented by a function expression, the controlling rendering of the first field in the web page based on the attribute information of the first field includes:
determining, based on the linkage information, a second field on which the first field depends; and rendering the first field based on the second field and the function expression.

Based on the sixth example of the first aspect, in a tenth example of the first aspect, when the attribute information of the first field further includes verification information of the first field, the method further includes:
verifying the first field based on the verification information upon receiving a fourth instruction on a form in the web page.

Based on the first to fourth examples of the first aspect, in an eleventh example of the first aspect, before the rendering the web page based on the web page outline information and a preset web page template, the method further includes:
extracting group information of the web page and/or scenario information of the web page from the web page outline information; and determining the preset web page template from at least one candidate web page template based on the group information and/or the scenario information.

In a first example of a second aspect, there is provided a web page generation apparatus. The apparatus includes:
a requirement description obtaining module, configured to obtain requirement description information of a web page;
an outline generation module, configured to input the requirement description information into an outline generation model to obtain web page outline information for describing web page logic;
a first rendering module, configured to render the web page based on the web page outline information and a preset web page template; and
a web page generation module, configured to generate the web page based on the web page outline information and the preset web page template in response to the web page being successfully rendered.

Based on the first example of the second aspect, in a second example of the second aspect, the outline generation module is further configured to:
generate a first vector of the requirement description information; separately match the first vector with a second vector of at least one existing component, to obtain at least one target existing component that matches the requirement description information, the second vector being a vector of component description information of the existing component; and input the requirement description information and a component identifier of the at least one target existing component into the outline generation model to obtain the web page outline information for indicating that the web page uses the at least one target existing component.

Based on the second example of the second aspect, in a third example of the second aspect, the apparatus further includes:
a first instruction receiving module, configured to receive a first instruction, the first instruction carrying a web page outline identifier of a target web page;
a web page outline obtaining module, configured to obtain web page outline information of the target web page based on the web page outline identifier of the target web page; and
a second rendering module, configured to render the target web page based on the web page outline information of the target web page and the preset web page template.

Based on the third example of the second aspect, in a fourth example of the second aspect, the apparatus further includes:
a second instruction receiving module, configured to receive a second instruction after the target web page is rendered based on the web page outline information of the target web page and the preset web page template; and
a first web page modifying module, configured to modify the web page outline information of the target web page and/or the preset web page template based on the second instruction.

Based on the first to fourth examples of the second aspect, in a fifth example of the second aspect, the apparatus further includes:
a third instruction receiving module, configured to receive a third instruction; and
a second web page modifying module, configured to input the third instruction and existing web page outline information into the outline generation model to obtain modified web page outline information, the third instruction being used for indicating a strategy for modifying the existing web page outline information.

Based on the first to fourth examples of the second aspect, in a sixth example of the second aspect, the first rendering module is further configured to:
extract attribute information of each first field in the web page from the web page outline information, the attribute information of the first field including at least one of: a type of the first field, a rendering strategy corresponding to the first field, a component identifier corresponding to the first field, and linkage information corresponding to the first field; and control rendering of the first field in the web page based on the attribute information of the first field.

Based on the sixth example of the second aspect, in a seventh example of the second aspect, when the attribute information of the first field includes the type of the first field and the component identifier corresponding to the first field, the first rendering module is further configured to:
determine a component corresponding to the component identifier corresponding to the first field as a first component if the component of the component identifier corresponding to the first field exists; or obtain, from the at least one existing component, a component corresponding to the type of the first field as a first component if the component identifier corresponding to the first field and/or the component corresponding to the component identifier corresponding to the first field does not exist; and render the first field in the web page in a form of the first component based on the rendering strategy corresponding to the first component, the rendering strategy being used for indicating whether the first field is read-only in the web page.

Based on the sixth example of the second aspect, in an eighth example of the second aspect, when the attribute information of the first field includes the rendering strategy of the first field, the first rendering module is further configured to:
obtain scenario information of the web page from the web page outline information; and match the scenario information with the rendering strategy to determine whether the first field is rendered in the web page in a read-only manner.

Based on the sixth example of the second aspect, in a ninth example of the second aspect, when the attribute information of the first field includes the linkage information corresponding to the first field, the linkage information being represented by a function expression, the first rendering module is further configured to:
determine, based on the linkage information, a second field on which the first field depends; and render the first field based on the second field and the function expression.

Based on the sixth example of the second aspect, in a tenth example of the second aspect, when the attribute information of the first field further includes verification information of the first field, the apparatus further includes:
a verifying module, configured to verify the first field based on the verification information upon receiving a fourth instruction on a form in the web page.

Based on the first to fourth examples of the second aspect, in an eleventh example of the second aspect, the apparatus further includes:
a group and scenario obtaining module, configured to extract group information of the web page and/or scenario information of the web page from the web page outline information before the web page is rendered based on the web page outline information and the preset web page template; and
a template selecting module, configured to determine the preset web page template from at least one candidate web page template based on the group information and/or the scenario information.

In a third aspect, according to one or more embodiments of the present disclosure, there is provided an electronic device. The electronic device includes: at least one processor and a memory.

The memory stores computer-executable instructions.

The at least one processor executes the computer-executable instructions stored in the memory, to cause the electronic device to implement the web page generation method of any one of the embodiments of the first aspect.

In a fourth aspect, according to one or more embodiments of the present disclosure, there is provided a computer-readable storage medium storing computer-executable instructions that, when executed by a processor, cause a computing device to implement the web page generation method of any one of the embodiments of the first aspect.

In a fifth aspect, according to one or more embodiments of the present disclosure, there is provided a computer program product including a computer program that, when executed by a processor, causes the method according to the first aspect to be implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast. the specific features and actions described above are merely exemplary forms of implementing the claims.

1. A web page generation method, comprising:
obtaining requirement description information of a web page;
inputting the requirement description information into an outline generation model to obtain web page outline information for describing web page logic;
rendering the web page based on the web page outline information and a preset web page template; and
generating the web page based on the web page outline information and the preset web page template in response to the web page being successfully rendered.

2. The method according to claim 1, wherein the inputting the requirement description information into an outline generation model to obtain web page outline information comprises:
generating a first vector of the requirement description information;
separately matching the first vector with a second vector of at least one existing component, to obtain at least one target existing component that matches the requirement description information, the second vector being a vector of component description information of the existing component; and
inputting the requirement description information and a component identifier of the at least one target existing component into the outline generation model to obtain the web page outline information for indicating that the web page uses the at least one target existing component.

3. The method according to claim 2, further comprising:
receiving a first instruction, the first instruction carrying a web page outline identifier of a target web page;
obtaining web page outline information of the target web page based on the web page outline identifier of the target web page; and
rendering the target web page based on the web page outline information of the target web page and the preset web page template.

4. The method according to claim 3, wherein after the rendering the target web page based on the web page outline information of the target web page and the preset web page template, the method further comprises:
receiving a second instruction; and
modifying the web page outline information of the target web page and/or the preset web page template based on the second instruction.

5. The method according to claim 1, further comprising:
receiving a third instruction; and
inputting the third instruction and existing web page outline information into the outline generation model to obtain modified web page outline information, the third instruction being used for indicating a strategy for modifying the existing web page outline information.

6. The method according to claim 1, wherein the rendering the web page based on the web page outline information and a preset web page template comprises:
extracting, from the web page outline information, attribute information of each first field in the web page, the attribute information of the first field comprising at least one of: a type of the first field, a rendering strategy corresponding to the first field, a component identifier corresponding to the first field, and linkage information corresponding to the first field; and
controlling rendering of the first field in the web page based on the attribute information of the first field.

7. The method according to claim 6, wherein in response to the attribute information of the first field comprising the type of the first field and the component identifier corresponding to the first field, the controlling rendering of the first field in the web page based on the attribute information of the first field comprises:
determining a component corresponding to the component identifier corresponding to the first field as a first component in response to an existence of the component corresponding to the component identifier corresponding to the first field; or
obtaining, from the at least one existing component, a component corresponding to the type of the first field as a first component in response to a non-existence of the component identifier corresponding to the first field and/or a non-existence of the component corresponding to the component identifier corresponding to the first field; and
rendering the first field in the web page in a form of the first component.

8. The method according to claim 6, wherein in response to the attribute information of the first field comprising the rendering strategy of the first field, the controlling rendering of the first field in the web page based on the attribute information of the first field comprises:
obtaining scenario information of the web page from the web page outline information; and
matching the scenario information with the rendering strategy to determine whether the first field is rendered in the web page in a read-only manner.

9. The method according to claim 6, wherein in response to the attribute information of the first field comprising the linkage information corresponding to the first field, the linkage information being represented by a function expression, the controlling rendering of the first field in the web page based on the attribute information of the first field comprises:
determining, based on the linkage information, a second field on which the first field depends; and
rendering the first field based on the second field and the function expression.

10. The method according to claim 6, wherein in response to the attribute information of the first field further comprising verification information of the first field, the method further comprises:
verifying the first field based on the verification information upon receiving a fourth instruction on a form in the web page.

11. The method according to claim 1, wherein before the rendering the web page based on the web page outline information and a preset web page template, the method further comprises:
extracting group information of the web page and/or scenario information of the web page from the web page outline information; and
determining the preset web page template from at least one candidate web page template based on the group information and/or the scenario information.

12. An electronic device, comprising: at least one processor and a memory, wherein
the memory stores computer-executable instructions; and
the at least one processor executes the computer-executable instructions stored in the memory, to cause the electronic device to implement a web page generation method, comprising:
obtaining requirement description information of a web page;
inputting the requirement description information into an outline generation model to obtain web page outline information for describing web page logic;
rendering the web page based on the web page outline information and a preset web page template; and
generating the web page based on the web page outline information and the preset web page template in response to the web page being successfully rendered.

13. The electronic device according to claim 12, wherein in the web page generation method,
the inputting the requirement description information into an outline generation model to obtain web page outline information comprises:
generating a first vector of the requirement description information;
separately matching the first vector with a second vector of at least one existing component, to obtain at least one target existing component that matches the requirement description information, the second vector being a vector of component description information of the existing component; and
inputting the requirement description information and a component identifier of the at least one target existing component into the outline generation model to obtain the web page outline information for indicating that the web page uses the at least one target existing component.

14. The electronic device according to claim 13, wherein the web page generation method further comprises:
receiving a first instruction, the first instruction carrying a web page outline identifier of a target web page;
obtaining web page outline information of the target web page based on the web page outline identifier of the target web page; and
rendering the target web page based on the web page outline information of the target web page and the preset web page template.

15. The electronic device according to claim 14, wherein in the web page generation method,
after the rendering the target web page based on the web page outline information of the target web page and the preset web page template, the method further comprises:
receiving a second instruction; and
modifying the web page outline information of the target web page and/or the preset web page template based on the second instruction.

16. The electronic device according to claim 12, wherein the web page generation method further comprises:
receiving a third instruction; and
inputting the third instruction and existing web page outline information into the outline generation model to obtain modified web page outline information, the third instruction being used for indicating a strategy for modifying the existing web page outline information.

17. The electronic device according to claim 12, wherein in the web page generation method,
the rendering the web page based on the web page outline information and a preset web page template comprises:
extracting, from the web page outline information, attribute information of each first field in the web page, the attribute information of the first field comprising at least one of: a type of the first field, a rendering strategy corresponding to the first field, a component identifier corresponding to the first field, and linkage information corresponding to the first field; and
controlling rendering of the first field in the web page based on the attribute information of the first field.

18. The electronic device according to claim 17, wherein in the web page generation method,
in response to the attribute information of the first field comprising the type of the first field and the component identifier corresponding to the first field, the controlling rendering of the first field in the web page based on the attribute information of the first field comprises:
determining a component corresponding to the component identifier corresponding to the first field as a first component in response to an existence of the component corresponding to the component identifier corresponding to the first field; or
obtaining, from the at least one existing component, a component corresponding to the type of the first field as a first component in response to a non-existence of the component identifier corresponding to the first field and/or a non-existence of the component corresponding to the component identifier corresponding to the first field; and
rendering the first field in the web page in a form of the first component.

19. The electronic device according to claim 17, wherein in the web page generation method,
in response to the attribute information of the first field comprising the rendering strategy of the first field, the controlling rendering of the first field in the web page based on the attribute information of the first field comprises:
obtaining scenario information of the web page from the web page outline information; and
matching the scenario information with the rendering strategy to determine whether the first field is rendered in the web page in a read-only manner.

20. A non-transient computer-readable storage medium for storing computer-executable instructions that, when executed by a processor, cause a computing device to implement a web page generation method, comprising:
obtaining requirement description information of a web page;
inputting the requirement description information into an outline generation model to obtain web page outline information for describing web page logic;
rendering the web page based on the web page outline information and a preset web page template; and
generating the web page based on the web page outline information and the preset web page template in response to the web page being successfully rendered.
